(19) United States
(12) Patent Application Publication
(10) Pub. No.: US 2009/0081936 A1
(43) Pub. Date: Mar. 26, 2009

(54) Salon ventilation system

(76) Inventor: Hoa Gia Luu, Berlin, MD (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/292,945

(22) Filed: Dec. 1, 2008

Related U.S. Application Data
(63) Continuation-in-part of application No. 11/903,780, filed on Jul. 28, 2008.
(60) Provisional application No. 60/967,027, filed on Sep. 1, 2007.

(51) Int. Cl. B08B 15/04; F24F 7/007

(52) U.S. Cl. 454/49; 454/341

(57) ABSTRACT

The salon ventilation system includes a wet/dry vacuum cleaner connected to main on/off power and speed control switches. The vacuum cleaner is connected to a manifold feeding a plurality of inlet port assemblies, each assembly being used in a respective manicurist station. Included are individual air input ports with respective shut-off valves or blocking caps. Each air input port is placed adjacent an open chemical jar to suction chemical fumes released therefrom. The manifold is placed behind walls or in a housing to cover the pipes and aesthetic purposes. The vacuum device has an output port that vents chemical fumes outside. The inventive ventilation system achieves odor control without the use of a ventilation hood. Moreover, if none of the stations is being used, power to the vacuuming device is turned off.

### CROSS-REFERENCE TO RELATED APPLICATION

This application is a continuation-in-part of prior U.S. patent application Ser. No. 11/903,780, filed Sep. 25, 2007, which claims the benefit of U.S. Provisional Patent Application Ser. No. 60/967,027, filed Sep. 1, 2007 both of which are hereby incorporated by reference in their entirety.

### BACKGROUND OF THE INVENTION

1. Field of the Invention

The present invention relates generally to exhaust systems, and, more specifically, to an exhaust system and method for venting chemical fumes originating in a nail salon to the outside environment.

2. Description of the Related Art

In a nail salon chemical fumes from nail products exist, notwithstanding the use of filtering devices, fume hoods, and the like.

During the course of a day's work, manicurists usually apply many artificial nails. Application of these artificial nails requires the process of combining acrylic powder, and a liquid monomer, usually contained in a jar. When the manicurist applies a mixture of the acrylic powder and monomer, the manicurist typically leaves the chemical jar open approximately between two and twenty minutes.

A major health concern and disadvantage is that the uncapped jar with the monomer evaporates past the manicurist's face, and is inhaled by the manicurists. The noxious fumes then waft into the space inside the nail salon, causing exposure to patrons, clinicians, and all who are in the salon, even though standard fan ventilation in the heating ductwork may be employed in an attempt to get rid of the harsh odor caused by the fumes. There needs to be an efficient, easily controllable, and esthetically pleasing method of ridding the salon of the aforementioned noxious chemical fumes.

Thus, a salon ventilation system solving the aforementioned problems is desired.

### SUMMARY OF THE INVENTION

The salon ventilation system comprises a wet/dry vacuum apparatus, a main on/off switch to control power to the vacuum apparatus, a speed control switch, a PVC piping manifold, and a plurality of inlet port assemblies. Each inlet port assembly is used in each manicurist station and includes an air input port with a shut-off valve or cap for blocking the input port when not in use. The air input port is used to suction chemical fumes released by an open chemical jar.

Each inlet port assembly is tied to the PVC piping manifold. The PVC piping manifold is coupled to the input of the vacuuming device and carries the chemical fumes from all the air input ports. The PVC piping manifold may be placed behind walls or placed in a housing to cover the pipes for aesthetic purposes.

An output port of the vacuuming device is directed to a hole chiseled on a wall or ceiling for venting the chemical fumes to the outside environment. When a station is not being used, the individual inlet port assembly of the station is shut-off. Moreover, the speed of the vacuuming device may be lowered. If none of the stations is being used, power to the vacuuming device is turned off. As such, the system saves energy and minimizes air and heat loss by using smaller pipes, individual controls on each inlet port assembly coupled with the speed control, and independent main power shut-off of the vacuuming device. Additionally, the ventilation system achieves odor control without the use of a ventilation hood.

These and other features of the present invention will become readily apparent upon further review of the following specification and drawings.

### BRIEF DESCRIPTION OF THE DRAWINGS

FIG. 1 is an environmental, perspective view of a salon ventilation system according to the present invention.

FIG. 2 is a perspective view of the discharge side of the wet/dry vacuum cleaner in the design of the ventilation at the point of application according to the present invention.

FIG. 3 is a perspective, partial cutaway view of the wet/dry vacuum cleaner's replacement position in between the ceiling tiles, and the roof for sound proofing according to the present invention.

FIG. 4 is a perspective view of the wet/dry vacuum cleaner's replacement position outside of the building for soundproofing according to the present invention.

FIG. 5 is a perspective view of the wet/dry vacuum cleaner's replacement position inside a contained room for sound control according to the present invention.

FIG. 6 is an exploded perspective view of inlet side attachment according to the present invention.

FIG. 7 is an exploded perspective view of system's discharge side primary attachment between PVC pipe, and flexible hose according to the present invention.

FIG. 8 is an exploded, perspective view of system's discharge side secondary attachment according to the present invention.

FIG. 9 is a perspective view of the system's discharge pipe end with a strainer according to the present invention.

FIG. 10 is a perspective view of the inlet port assembly according to the present invention.

FIG. 11 is a perspective, partial cutaway view of inlet port assembly, and a replacement position of piping inside the partition wall according to the present invention.

FIG. 12 is a perspective view of replacement method shutting off suction for inlet port with the use of pipe cap in the absence of shutoff valve according to the present invention.

FIG. 13 is a perspective view of replacement inlet port (prefabricated) according to the present invention.

FIG. 14 is a perspective, partial cutaway view of replacement position of PVC pipe manifold under concrete subfloor according to the present invention.

FIG. 15 is a perspective view of replacement position of PVC pipe leading from inlet port assemblies to wet/dry vacuum cleaner, if vacuum cleaner replacement position is between the ceiling tiles, and the roof according to the present invention.

FIG. 16 is a perspective, partial cutaway view of PVC pipe manifold inside plywood box in FIG. 1 according to the present invention.

FIG. 17 is a perspective view of replacement material in the absence of PVC piping manifold according to the present invention.

FIG. 18 is a perspective, partial cutaway view of PVC piping manifold inside plywood box cover according to the present invention.

Similar reference characters denote corresponding features consistently throughout the attached drawings.

### DETAILED DESCRIPTION OF THE PREFERRED EMBODIMENTS

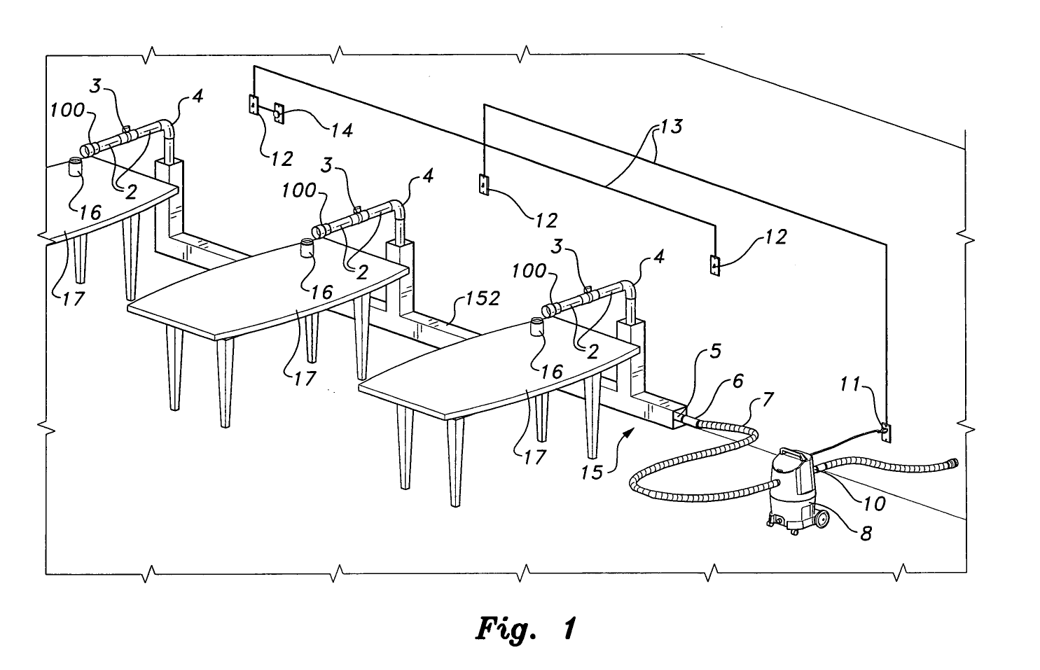

The salon ventilation system, as shown in FIG. 1, includes a wet/dry vacuum cleaner 8 having wire connections 13 to a.c. mains switched outlet 11 via local on/off power switches 12 and speed control 14. Vacuum cleaner 8 is connected to a manifold 5 feeding a plurality of inlet port assemblies 100, each assembly 100 being used in a respective manicurist workstation 17. The assemblies 100 may include a section having valve 3, a plurality of linear sections 2, and an elbow joint 4. To maintain positive ventilation, the length of a main header of the manifold should not exceed eighty feet from vacuum cleaner 8. Vacuum cleaner 8 preferably has a minimum of between 5-6.5 horsepower. Included with the individual air input ports 100 are respective shut-off valves 3 or blocking pipe caps 39.

Each air input port 100 is used to suction chemical fumes released by an open chemical jar 16. The manifold 5 is placed behind walls or in a housing 15 having a plurality of inlet pipe covers 150 joining a header cover 152 to cover the pipes for esthetic purposes. The vacuum device 8 has an output port 10 that vents chemical fumes outside. The ventilation system achieves odor control without the use of a ventilation hood. Moreover, if none of the stations 17 is being used, switched outlet 11 and switches 12 allow power to the vacuuming device 8 to be turned off.

As most clearly shown in FIG. 1, there is one assembly 100 for each station, multiple assemblies (3 as shown) being tied together by the interconnection of tri-directional, i.e., “T section” PVC adapters 48, with horizontally and vertically disposed linear sections of PVC pipes, the pipe sections being attached together to make up one entire manifold 5. The attachments may be secured by application of PVC plumber's glue at the joints.

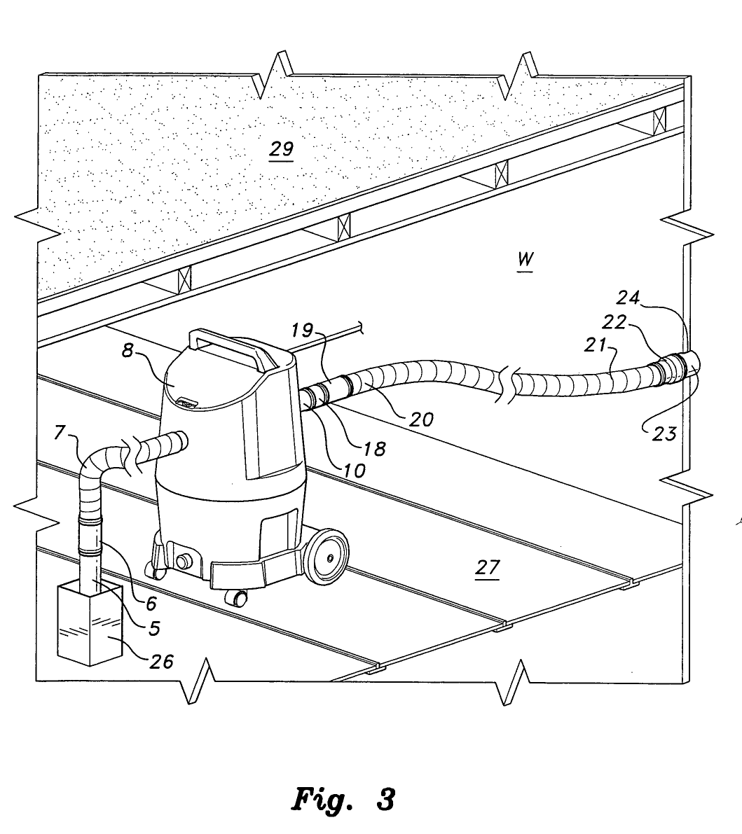

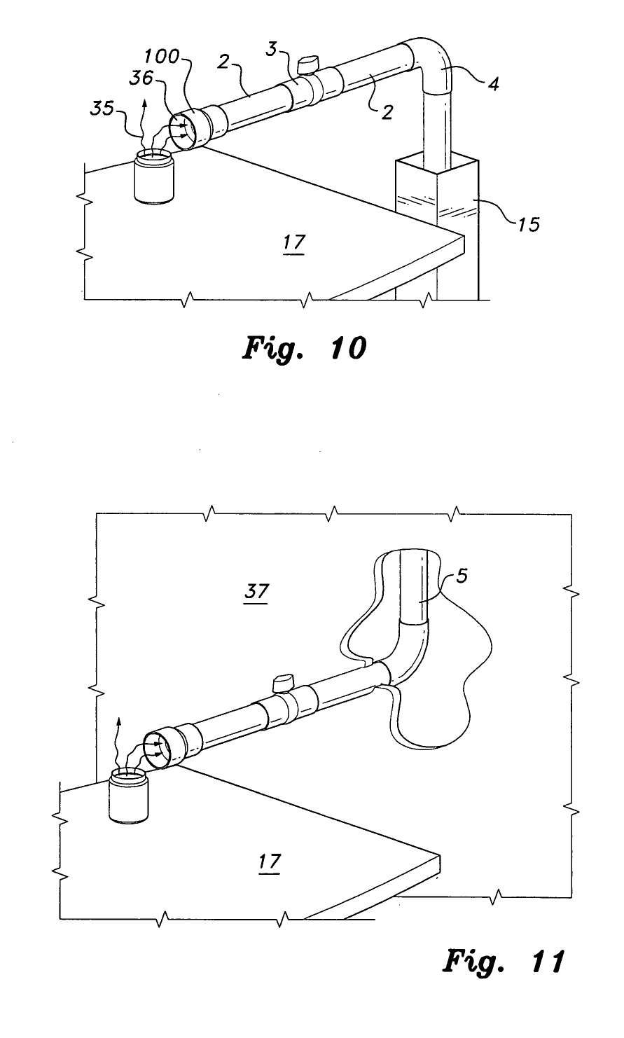

As shown in FIG. 10, each assembly is mounted 90° from a vertically disposed PVC pipe belonging to manifold 5, and configured parallel to and proximate to the nail station/table 17 (preferably just above table level). Moreover, a power switch 11 is associated with each station 17 and assembly 100. The power switches 12 are wired to the receptacle 11 at the site of the wet/dry vacuum cleaner 8 in a three-way configuration. Speed switch 14 is operably connected to control the motor speed of vacuum cleaner 8. If the design of the nail salon does not allow for laying the nail tables 17 against the wall, then, as shown in FIG. 11, the manifold 5 may be disposed within 2-by-6 wood partition walls 37, the partition walls 37 being built from the ceiling to the floor. Nail service tables can be placed against partition walls 37. The suction pipes extend inside a cavity created by the partition walls 37 from the table surfaces to the site of the wet/dry vacuum cleaner, as shown in FIGS. 3-5, through a cavity of the ceiling.

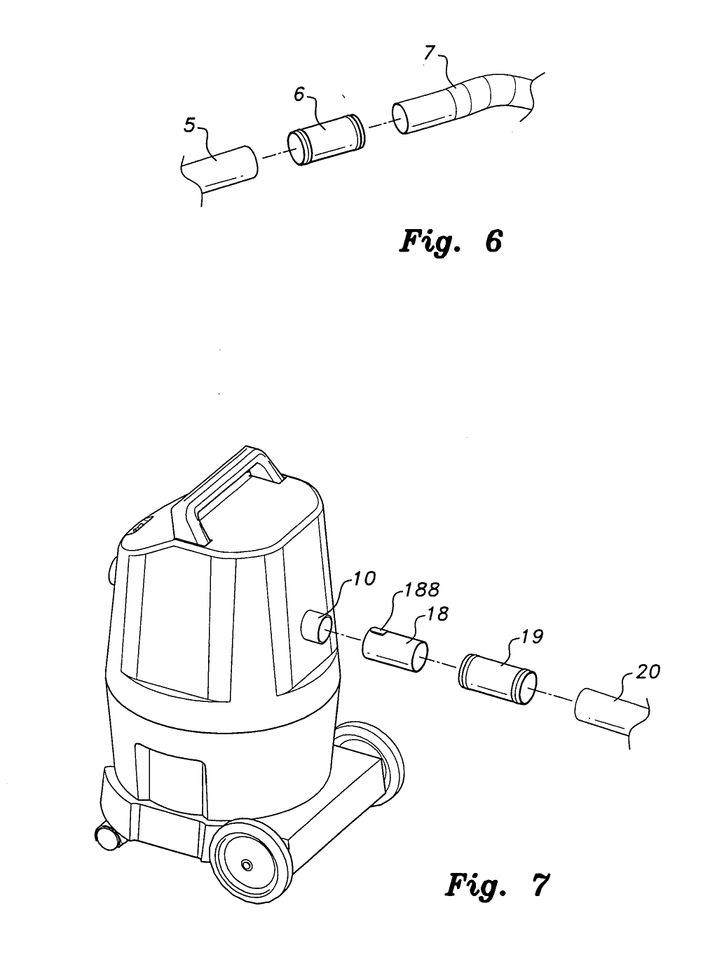

Referring to FIGS. 1 and 6, the manifold is connected to the wet/dry vacuum cleaner via the pipe fitting 6 and flexible hose 7. The end of PVC pipe 5, and the entry end of flexible hose 7 are both inserted into both ends of rubber pipe fitting 6, and tightened by a band/C-clamp. Wooden manifold cover 15 covers the exposed PVC piping manifold, 5.

When configured as shown, vacuum suction from the salon ventilation system causes fumes 36 emanating from chemical containing jar 16 to enter the suction hose via inlet port 100 and be transported outside the salon. The fumes are drawn into the vacuum cleaner 8 and then discharged out of tubular port 10.

As shown in FIG. 8, downstream primary attachment is comprised of discharge port 10, spacer 18b with tube locking mechanism 18a, a tube-like spacer inserted inside of rubber pipe connector 19, and flexible hose end 20 inserted into a remaining end of the rubber pipe connector 19. The aforementioned connection is secured with a band or C-clamp around the rubber pipe connector. The secondary discharge attachment downstream includes flexible hose and provides a passageway for the suctioned malodorous fumes. The secondary end of discharge flexible hose 21 is inserted inside into one end of rubber pipe connector 22. Discharge pipe 23 is inserted into the remaining end of the rubber pipe connector. B and/or C-clamps tighten both ends of the connector 22 to keep the attachment stationary.

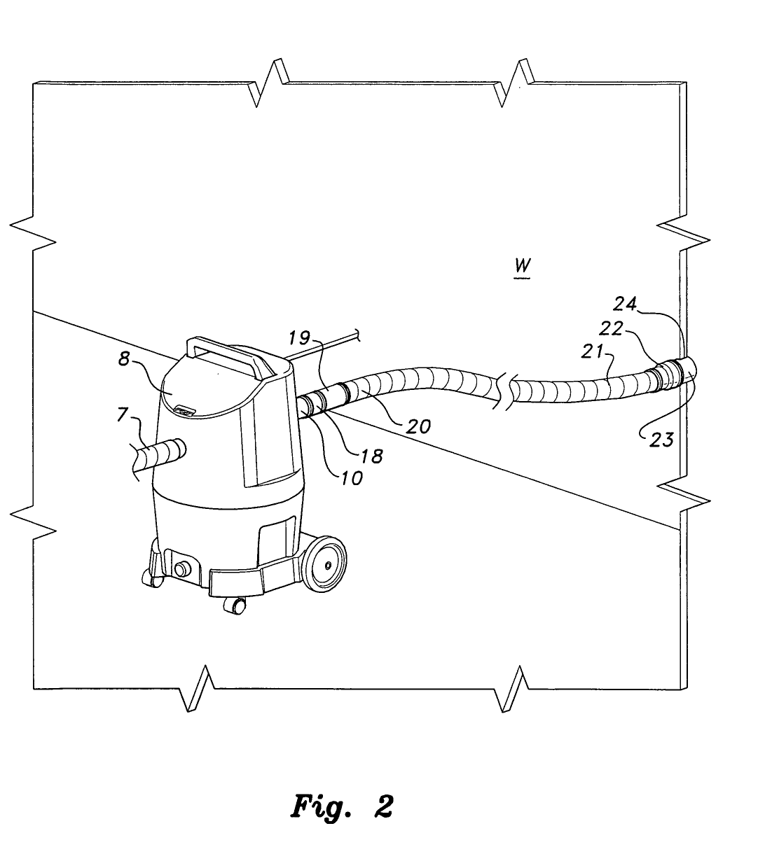

As shown in FIG. 2, the discharge port 10 is connected vial lock mechanism 188 to spacer 18, the tube-like spacer being inserted inside of rubber pipe connector 19, and flexible hose end 20 inserted into the other end of said rubber hose connector, and tightened by band/or C-clamp around rubber pipe connector 21. Discharge interface connector 22 joins rubber pipe connector 21 to discharge pipe 23. PVC discharge pipe 23 is arranged to transport the odor to the other side of building wall 25 through the chiseled hole 24. As shown in FIG. 6, PVC connector 23 is glued to interconnector 22, a strainer 30 is glued to the end of the connector 23, to prevent foreign objects from clogging the pipe.

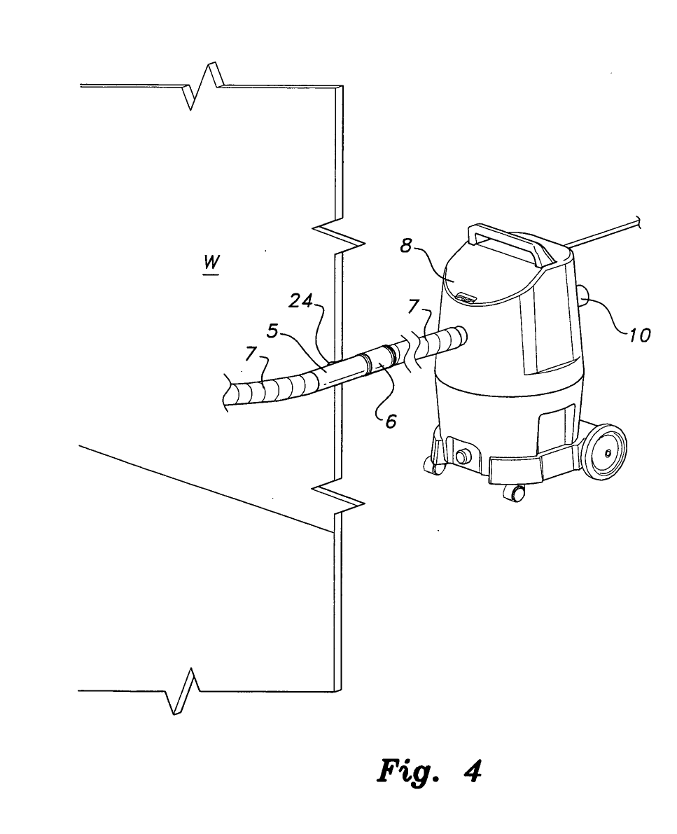

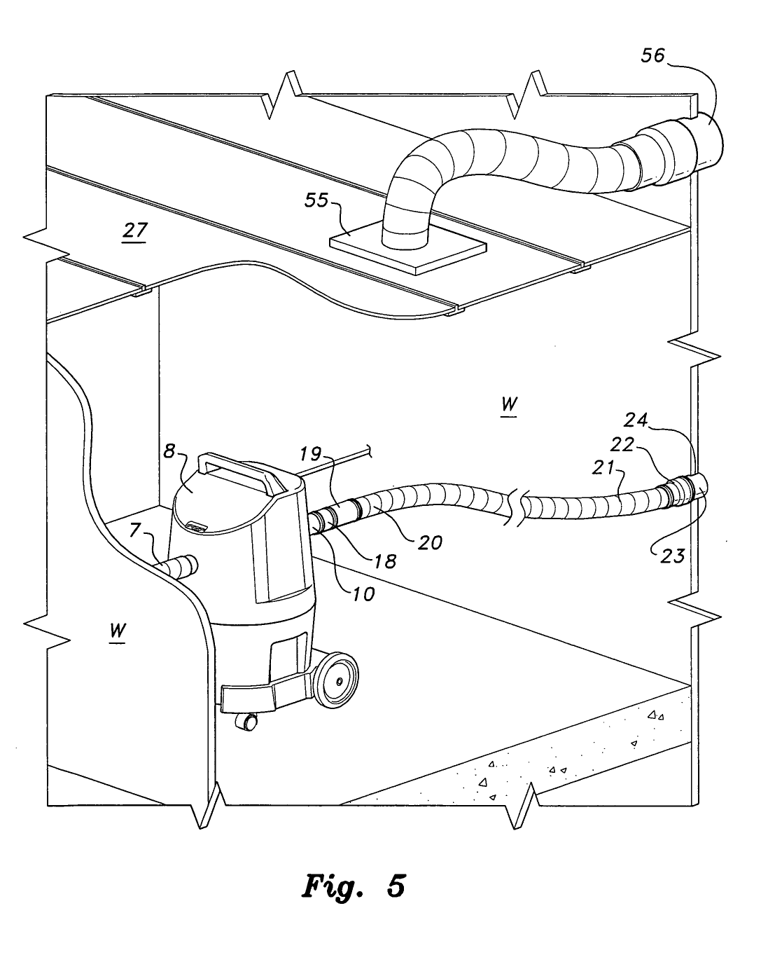

The wet/dry vacuum cleaner 8 is the primary component for removing nail odor. The vacuum causes substantial noise, therefore having the noise contained is important. If space is not available, alternate methods are used to hide the vacuum cleaner to sound proof the noise level, e.g., in between the ceiling tiles and the roof, as shown in FIG. 3, or, contained inside a room 30, with the door being closed, as shown in FIG. 5, or, outside the building, as shown in FIG. 4. When necessary, downstream discharge attachment, and piping may be omitted, as shown in FIG. 2.

As shown in FIG. 10, when a chemical container is opened, chemical odor 35 is released at the onset of evaporation. The chemical container 16 is preferably placed one to four inches from the inlet port 100. When the wet/dry vacuum cleaner 8 is powered up, the contaminated air 35 is diverted to airstream 36 and extracted into inlet port 100. The odors are drawn from the side of opened chemical container 16, thereby preventing the fumes from being inhaled by the manicurist and customer. Under suction pressure, the fumes travel through the manifold 5 into the wet/dry vacuum cleaner 8, and are exhausted from the building.

As shown in FIG. 5, the wet/dry vacuum cleaner 8 may be placed inside a vacuum discharge room 30, the room being isolated by a door to lower the noise level. The room may also be built at the end of the nail salon away from the service station so that the manifold piping 5 extends from the service station to the vacuum discharge room 30, through a cutout hole, and to the site of the vacuum 8 for connection. If the discharge room 30 is built a wall away from the outside, then the discharge pipe 23 should be very short, and a secondary discharge attachment, as shown in FIG. 8, is still used. Ends of rubber pipe connector 22 are secured to discharge pipe 23 and connector pipe extension 21 by ring locks 226 and 228, respectively. Alternatively, a vent 55 may be disposed in the ceiling and, in combination with the vent 55, a wall mounted exhaust fan 56 may supplement removal of the noxious fumes discharged into room 30.

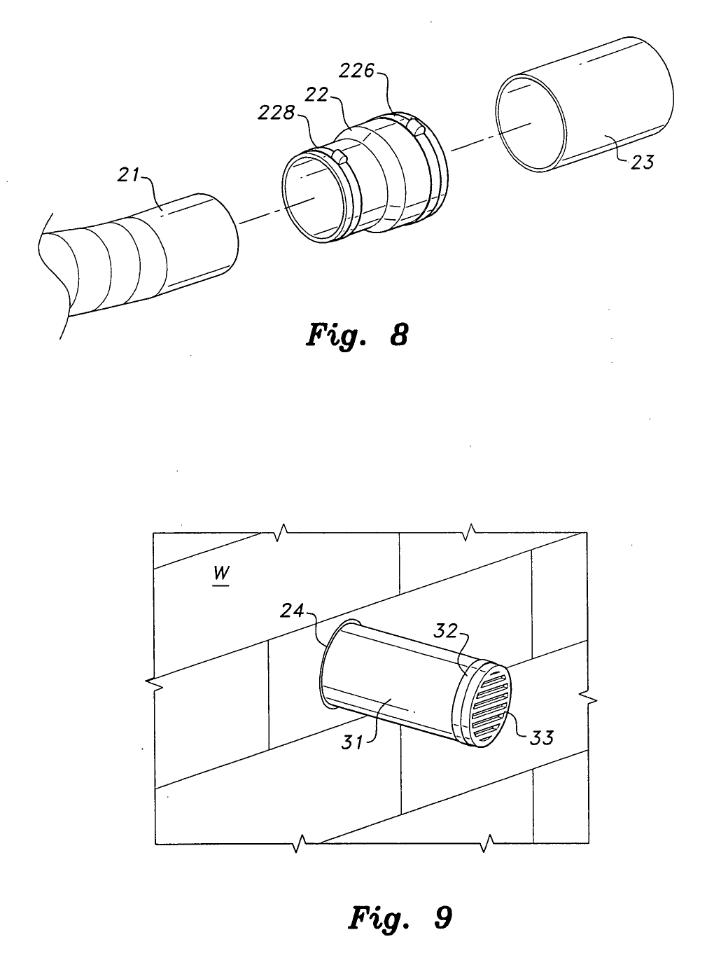

As shown in FIGS. 3, 5, 8 and 9, an excess length of PVC discharge pipe 23 hanging in the back wall of the nail salon can be inserted inside a strainer housing 31, and glued. Free end of the strainer housing 31 includes a strainer 33 secured by strainer ring connector 32. The strainer 33 protects the discharge piping 23 from getting clogged.

As shown in FIGS. 6, 7, and 8, rubber pipe connectors 6, 19, and 22 provide universal connections between PVC pipes 5 and 23, and flexible hoses 7 and 21, along with wet/dry vacuum cleaner 8. The aforementioned connectors allow the fume suctioning system to be constructed utilizing flexible hoses. As shown in FIG. 10, the primary entry of inlet port 100 extends parallel to the surface of table 17, thereby allowing a very neat fumes intake on the table. Moreover, the aforementioned configuration uses minimal space. When needed, the manicurist simply places the chemical containing jar 16 close to the opening of the inlet port 100. When the system is turned ON by the local switch 11, the manicurist slowly opens the cap of the jar, allowing the odor to be suctioned via inlet port 100 thereby preventing odor from remaining in the nail salon's environment.

As shown in FIG. 11, an alternative pipe layout, is configured wherein 2 by 6 wood partition walls 37 are built from the ceiling to the floor. Nail service tables are placed against the partition walls 37. Odor suctioning conduits extend inside the cavity of partition walls 37 from the surface of the table to the site of the wet/dry vacuum cleaner 8, as shown in FIGS. 3, 4 and 5, through the cavity of the ceiling.

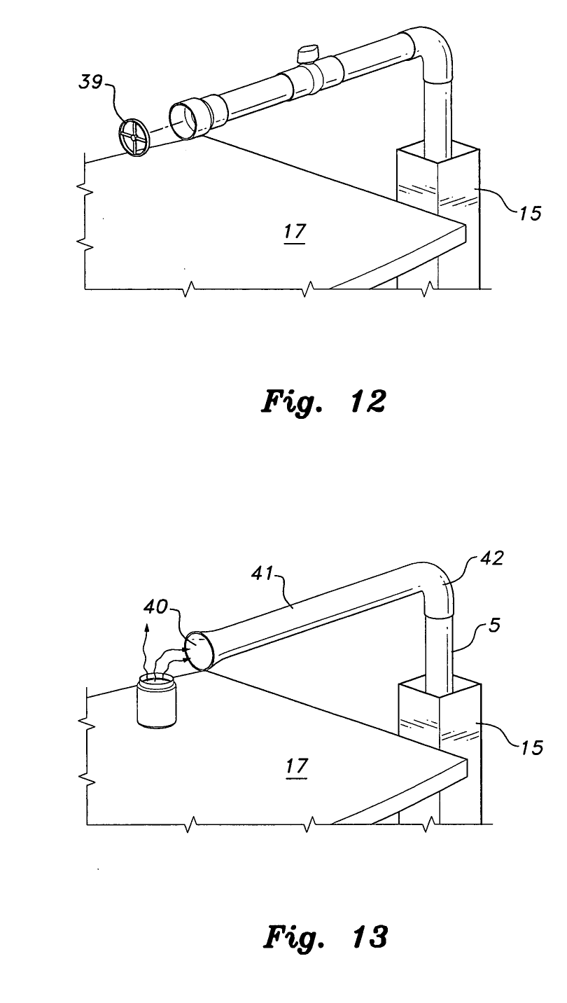

As shown in FIG. 12, pipe caps 39 are used in lieu of shutoff valves 3, to cut cost, and for quick-acting stop suction of each inlet port 100. The cap 39 stops the incoming air at inlet port 100 to thereby silence the system in the vicinity of the service table 17 when the chemical is not being used there.

As shown in FIG. 13, alternative to hanging the PVC pipes on the service tables, a prefabricated inlet port 41 having an inlet orifice 40 and an elbow connection portion 42 may be provided. To offer a better decoration to the salon, a variety of colors is available.

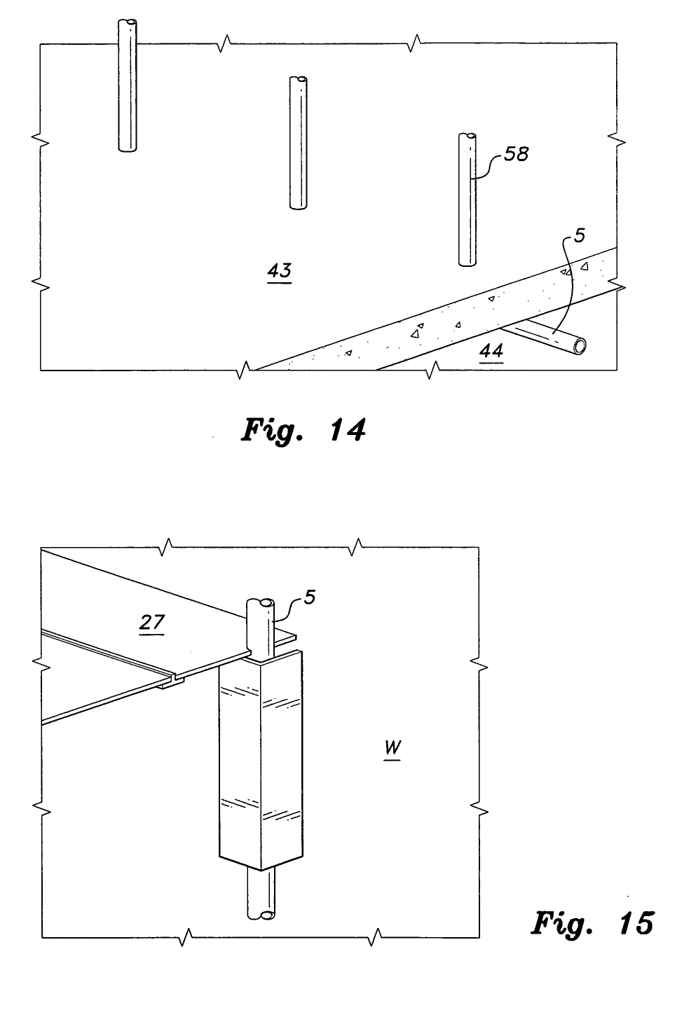

As shown in FIG. 14, the PVC pipes may be extended in a crawl space 44 underneath concrete subfloor 43, but this idea is only recommended for preconstruction of a new nail salon to hide exposure of the pipes when the inlet port assemblies can be attached directly on top of the pipes. In this instance, manifold covering 15 also surrounds the pipes 5.

As shown in FIGS. 3 and 15, an alternate location for the wet/dry vacuum cleaner is in between ceiling tiles 27 and roof 29. The pipes extend from the cavity of the ceiling downward in a substantially vertical manner, preferably in the back of the nail salon, where the end of this pipe meets the end of manifold piping 5 from the service stations. At this point, two ends are joined by a PVC pipe elbow. All pipes are enclosed by housing 26. Moreover, in the aforementioned vertical configuration, the manifold 5 may be disposed along a vertical wall W.

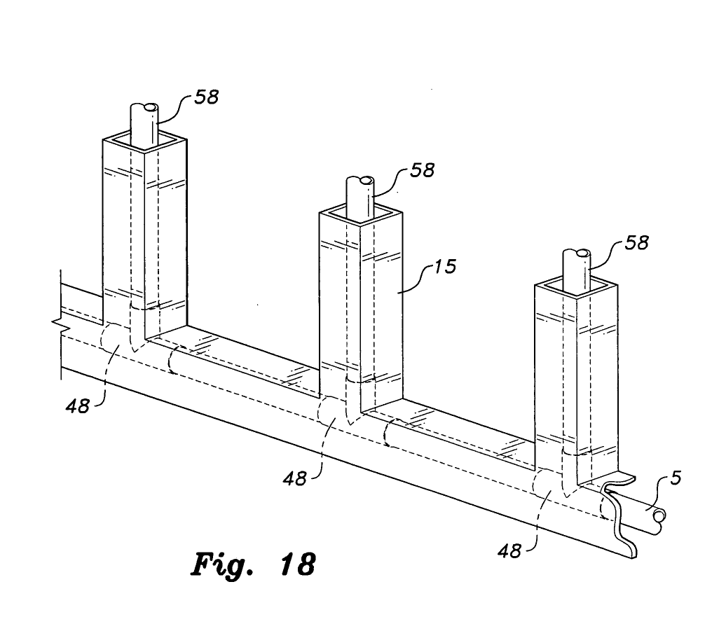

As shown in FIGS. 16 and 18, service tables are placed against the right wall of the nail salon, so that PVC pipes are easily place in the base corner of the wall. The header of manifold 5 extends along the wall. Individual runners 58 of the manifold 5 are connected to the header portion via T connector 48. The pipes are enclosed and run to the back of the nail salon to connect to the wet/dry vacuum cleaner 8.

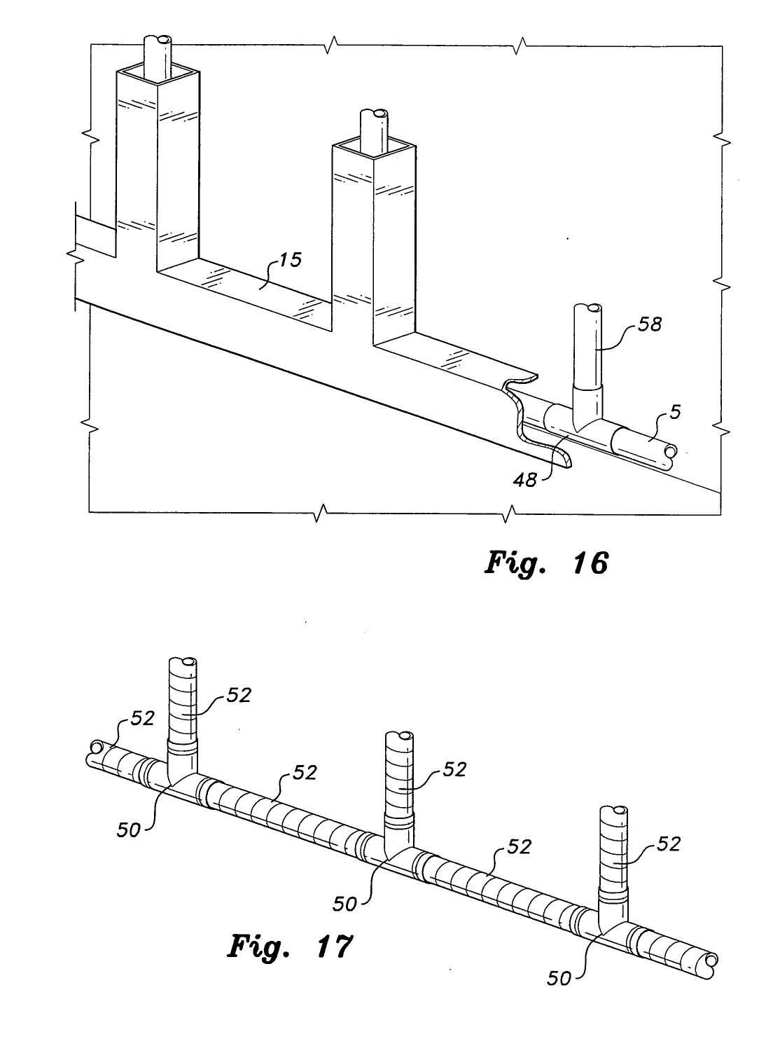

As shown in FIG. 17 replacement flexible hoses 52 may be used in lieu of PVC pipes, along with the tri-directional, “Tee”/“T” rubber pipe connectors 50. Rubber Tees may also used to tie hoses 52 together, but this method is not recommended due to the cost of flexible hoses.

It is to be understood that the present invention is not limited to the embodiment described above, but encompasses any and all embodiments within the scope of the following claims.

I claim:

1. A salon ventilation system, comprising:
a vacuum source having a suction inlet and a discharge port, the discharge port being adapted for discharging noxious fumes to a remote location opposite an interior boundary of the nail salon;
at least one inlet conduit having a first end in operable communication with the suction inlet and a second end positioned proximate a source of noxious fumes emanating from a workstation of the nail salon;
a discharge pipe connected to the discharge port, the discharge pipe being adapted for directing exhaust outside an immediate environment of the nail salon;
means for blocking suction at the second end of the at least one inlet conduit; and
an electrical switch operably connected to the vacuum source, the electrical switch being disposed proximate the nail salon workstation.

2. The salon ventilation system according to claim 1, wherein the electrically powered vacuum source comprises a wet/dry vacuum cleaner.

3. The salon ventilation system according to claim 1, wherein the means for blocking suction comprises a valve disposed in the at least one inlet conduit in proximity to the workstation.

4. The salon ventilation system according to claim 1, wherein the means for blocking suction comprises a cap removably disposed over the first end of the inlet conduit.

5. The salon ventilation system according to claim 1, wherein said at least one inlet conduit comprises a plurality of conduits forming a manifold, the manifold being in operable communication with the suction inlet of the vacuum source, the plurality of inlet conduits having ends suctioning fumes at a respective plurality of nail salon workstations.

6. The salon ventilation system according to claim 5, wherein said manifold has a header adapted for placement along an interior wall of the nail salon.

7. The salon ventilation system according to claim 5, wherein said manifold has a header adapted for placement between an interior wall and an exterior wall of the nail salon.

8. The salon ventilation system according to claim 5, wherein said manifold has a header adapted for placement between a ceiling and a roof of the nail salon.

9. The salon ventilation system according to claim 5, wherein said manifold has a header adapted for placement under the floor of the nail salon.

10. The salon ventilation system according to claim 5, wherein said manifold has a header adapted for placement within an interior wall of said nail salon.

11. The salon ventilation system according to claim 5, said manifold has a header and a housing enclosing the header.

12. The salon ventilation system according to claim 1, further comprising a speed switch operably connected to the vacuum source, the speed switch regulating speed of the vacuum source, thereby controlling noise level of the salon ventilation system.

13. The salon ventilation system according to claim 1, further comprising sound insulation material disposed around the vacuum source for shielding the salon from noise generated by the vacuum source.

14. The salon ventilation system according to claim 1, wherein further comprising ceiling ductwork and an exhaust fan disposed in operable communication with said discharge pipe for removing the noxious fumes from an interior space of the remote location.

15. The salon ventilation system according to claim 1, further comprising:
a hollow strainer housing having open first and second strainer housing ends; and
a strainer blocking foreign objects while allowing exhaust to flow through.
